(19) United States
(12) Patent Application Publication
(10) Pub. No.: US 2013/0077822 A1
(43) Pub. Date: Mar. 28, 2013

(54) METHOD FOR CREATING AN INDEX USING AN ALL-IN-ONE PRINTER AND ADJUSTABLE GROUPING PARAMETERS

(71) Applicant: JOHN RANDALL FREDLUND, Rochester, NY (US)

(72) Inventor: JOHN RANDALL FREDLUND, Rochester, NY (US)

(21) Appl. No.: 13/247,246

(22) Filed: Sep. 28, 2011

(51) Int. Cl. G06K 9/00; G06K 15/02

(52) U.S. Cl. 382/103; 358/1.15

(57) ABSTRACT

A method for indexing and printing images on a printing system, the method includes inputting images with metadata into the printing system; by means of the metadata, selectively grouping the images into a plurality of groups by a controller of the printing system; selecting at least one representative image as an index image from each group; selecting an output format; and using the index images to create a index image file corresponding to the selected output format.

### FIELD OF THE INVENTION

The present invention relates to the use of the memory card reader and printer portions of an All-in-one printer to create a representative index of files on a memory card.

### BACKGROUND OF THE INVENTION

All-in-one (AIO) printers such as the ESP C310 provided by the Eastman Kodak Company are popular devices for home and office that perform multiple useful functions. A plurality of subsystems is combined into a single printing system. These subsystems include:
A scanner for capturing images of documents and photographs.
A memory card reader for reading files from inserted memory cards.
A printer, typically using ink jet technology, for marking media such as plain paper or photo paper.
A display for instructing the user in operation of the device
User inputs such as buttons or a touch screen
At least one processor or controller, which can reside in one of the subsystems, for controlling the activity of the subsystems. The processor also includes or has access to memory in the AIO for storing programs.

The subsystems are used separately or in combination to provide useful functionality. An example of use in combination is copier functionality. The controller instructs the scanner to create an image of a document that rests on the scanner platen, and then instructs the printer to print a duplicate of the scanned image.

While current AIO printers provide this combinatorial functionality, the uses of the subsystems are not so limited. The present invention enables new methods of use.

In U.S. Pat. No. 6,571,054, Tonamura teaches creation of an electronic image book from a video. Here the number of electronic pages in the book-type interface is not limited by the physical size of the output media, and the user is required to specify representative images and methods of layout for images.

European Application Publication 2089886 is directed toward selection of keyframes in a video record using sub-shots determined on the basis of differing content. There is no limitation to the number of keyframes selected.

In U.S. Pat. No. 7,831,599, images are grouped based on chronology. Clustering is additive, and re-clustering is avoided.

US Publication 20040245128 discloses a media storage and organization system for physically holding a memory device such as a CD. There is no method for determining what index images are selected and in what manner these images are printed on the index print.

What is needed is a method for optimizing the balance between the number of groups of images on a memory device and the available space on a printed index of the images on the device.

### SUMMARY OF THE INVENTION

The present invention is directed to overcoming one or more of the problems set forth above. Briefly summarized, according to one aspect of the invention, the invention resides a method for indexing and printing images on a printing system, the method includes inputting images with metadata into the printing system; by way of the metadata, selectively grouping the images into a plurality of index groups by a controller of the printing system; selecting at least one representative image as an index image from each index group; selecting an output format; using the index images to create an index output file; and printing the index output file.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a simplified block diagram of an All-in-one printer;

FIG. 2 shows a menu for selecting index print format on the display of the AIO;

FIG. 3 shows a menu for selecting index image size on the display of the AIO;

FIG. 4 shows a form for selecting index print format and index image size;

FIG. 5 is a representation of an index print created by the present invention;

FIG. 6 is a representation of an index print created by the present invention;

FIG. 7 is a representation of an index print created by the present invention;

FIG. 8 is a representation of an index print created by the present invention; and

FIG. 9 is a flowchart of steps according to the present invention.

### DETAILED DESCRIPTION OF THE INVENTION

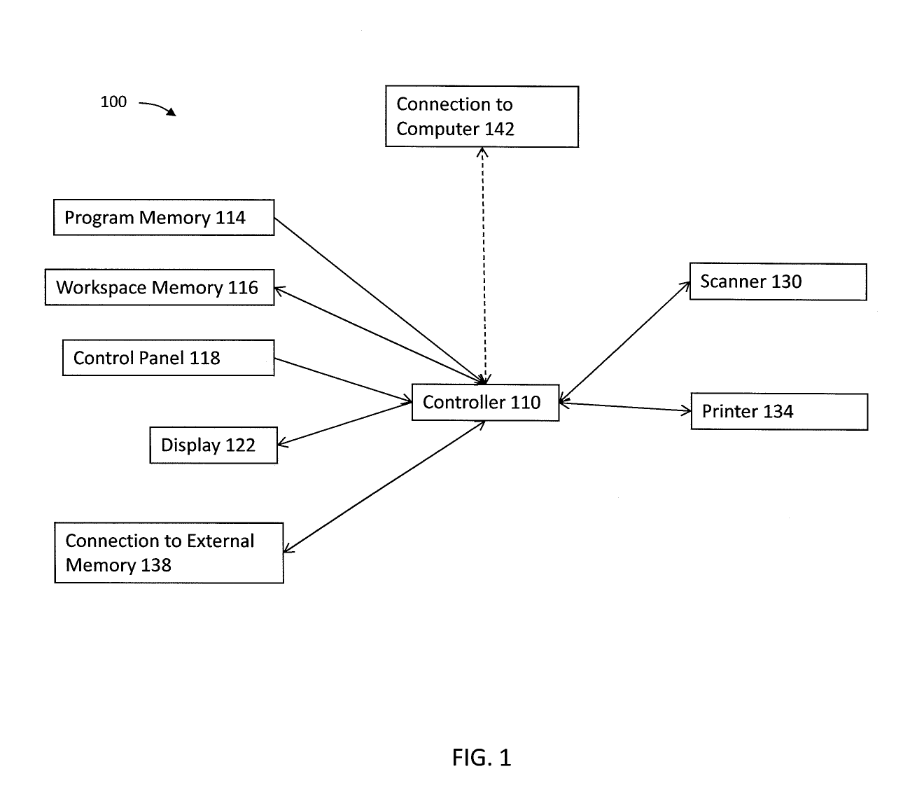

FIG. 1 is a simplified block diagram of all-in-one (AIO) printer 100, as an example of a printing system. Controller 110 is a processor with sufficient computational power and input/output (I/O) to control the operations of all-in-one printer 100. Controller 110 executes instructions located in program memory 114. Workspace Memory 116 is used by controller 110 to store and operate on data. Controller 110 responds to inputs provided via control panel 118. Operational feedback is provided to the user by display 122. Display 122 can be of many forms including an LCD panel and LED lamps. Scanner 130 is connected to controller 110 and is controlled by controller 110 to provide image data of documents placed on the platen (not shown) of scanner 130. Printer 134 is controlled by controller 110 to print images and documents. Connection to external memory 138 is a memory card acceptor. This connection can be multi-format to accept many different types of external memory such as CF, SD, micro-SD, Flash Drives and the like. Connection to computer 142 can be of a wired type such as USB or wireless such as WiFi.

AIO printer 100 can be used to create index output files and index prints representative of files residing on memory devices. A common use pattern for memory devices has emerged with an abundance of memory available at low cost. Many users fill their memory devices and never erase them for reuse. Since memory is available at low cost, full- or partially-full memory devices are cast aside or stored and new devices are purchased for further storage. Unfortunately, the contents of these devices are soon forgotten or the device upon which a particular file resides is confused, since multiple memory devices accumulate, and there is little ability to organize them. Although some files such as documents typically have file names that provide information as to the content of the file, file names of images transferred directly from a camera typically do not have descriptive file names. A simple printed listing of file names in such cases would not provide adequate information to indicate the content or subject matter of such files. In addition, it is typically not practical to print small representations of each of the image files on the memory device, because there are typically too many. AIO printer 100 has the capability to provide a solution to these problems.

A preferred embodiment is described with regard to images stored on a memory device. A memory device (not shown) is inserted into connection to external memory 138. Controller 110 can automatically sense that a memory device has been inserted into connection to external memory 138 or the user can indicate the presence of the inserted device via control panel 118. Options are displayed on display 122, and the user indicates preferences via control panel 118. Upon receiving input indicating selection of forming an index of files on the inserted device, controller 110 reads images residing on the memory device and stores them in workspace memory 116. It is likely that the available workspace memory 116 available is insufficient to import the images on a memory card containing a large number of files. In this case, the AIO reads only a portion of the images at any time, or in a preferred embodiment, reads only the index images, sometimes referred to as thumbnails, associated with images.

Executing instructions from program memory 114, controller 110 groups images into a plurality of groups. The files can be grouped on the basis of time and date as taught in U.S. Pat. No. 7,869,658. This provides grouping that is likely to cluster files together that are associated with a particular event. The files can also be grouped according to other characteristics. Different types of files can be grouped. Image files can be grouped together, video files grouped together, audio files grouped together and documents grouped together. The differing types of files can be grouped both by type and date and time. Files can first be grouped by date and time, and within the date and time files can then by type. Alternatively, files can first be grouped by type and then by date and time within the type groupings.

Representative imagery is selected from each group. Representative imagery can be selected in many fashions. Position in the group on the basis of date and time can be used to select the first image, last image, or some image positioned between to represent each group. Image content can be analyzed to provide the representative image. Image content analysis of this type entails identification of image objects within the captured scene. Preferred objects for representation, such as faces, are given priority in selecting the representative imagery. Controller 110 does the analysis, or can use metadata supplied in the files read from the memory device. Frequency of detection of faces content within a group or within an image can be given priority in determining representative imagery. Face detection is well known in the art and will not be discussed herein.

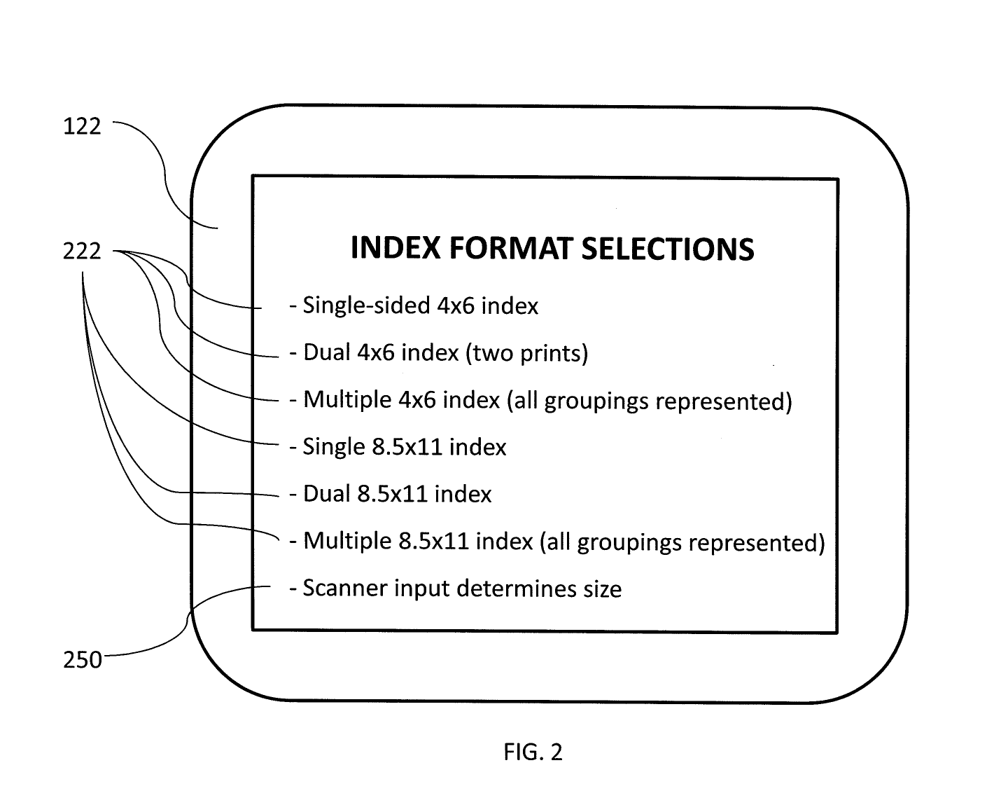

Output format is selected for the printed index. This can happen by several means. As shown in FIG. 2, the user can select a particular format by way of control panel 118. For example, from options 222 shown on display 122, the user can select “single-sided 4×6 index” for an output size where the index is printed on a single sided 4×6 sheet of photo paper. Other options include, but are not limited to:
Dual 4×6 index (two sheets are used for representative imagery)
Multiple 4×6 index (as many as needed for representations of groupings)
Single 8.5×11 index
Dual 8.5×11 index

A particular selection for output format, such as “single sided 4×6 index” can be the default. Holders, binders, plastic bags or other means in the proper size and shape for the selected output format can be provided to keep the index print and the memory device together. Usefulness of the memory device is enhanced when the index print is held together with the device so that the devices with particular files can be quickly located for use. Additionally, a line or lines printed on the index print according to the selected output format can provide indications for folding, taping or gluing such that the index print can contain the memory device, or fit in the associated holder.

Output format can also be selected through the use of the scanner 130. Scanner 130 is used as an input device so that the AIO can determine the desired size for printing the index imagery. A card that contrasts in color from the background of the cover of the AIO can be used. The user places media such as the card of contrasting color on the platen of scanner 130. Scanner 130 scans the card, and controller 110 automatically determines the size by methods known in the art, and controller 110 uses that size for printing the index print. This size can be stored for future usage. The user selects “Scanner input determines size” option 250. As directed by controller 110, scanner 130 scans the card and differentiates it from the background to determine the size of the desired index print. In this fashion, the user need not be constrained by standard sizes. The user is directed to place standard size media larger than the scanned card into printer 134 for printing the custom size index print. The standard size media can be cut by the user after printing.

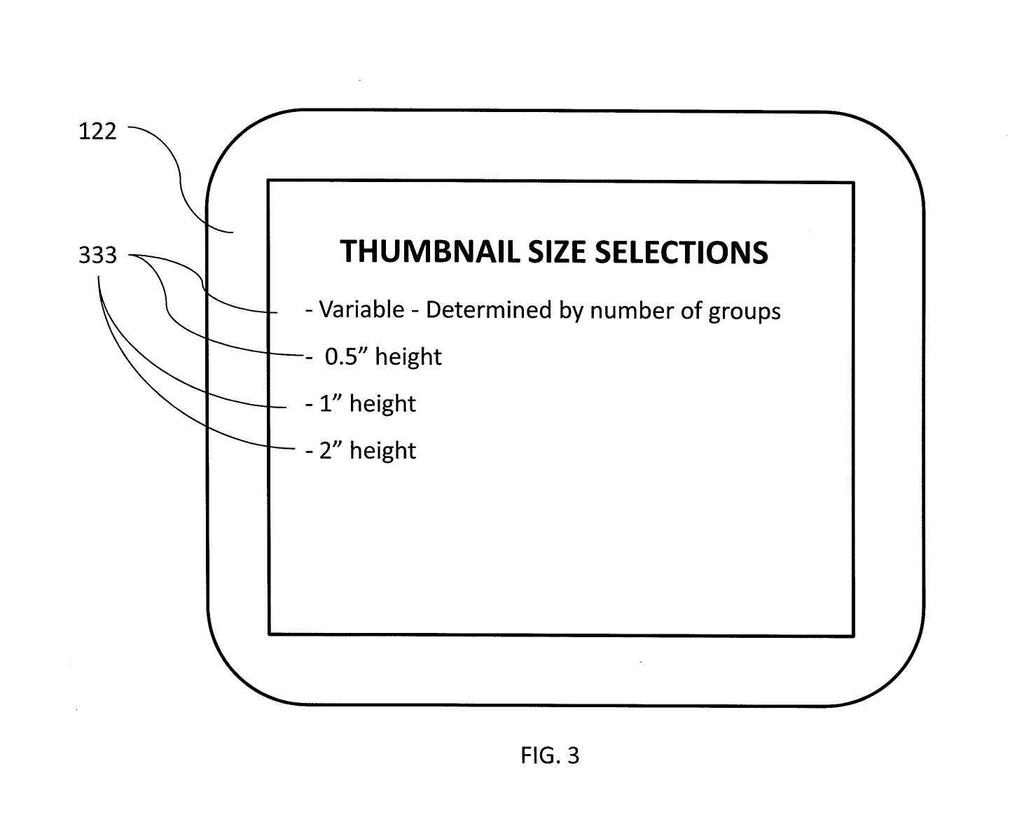

It is an advantage to determine the size of indexes and number of index images printed on the selected index print. As shown in FIG. 3, selection of sizes of index images printed can be provided by making selections from a menu on display 122. Selections 333 specify the size of index images. By selecting a size for index images, the user also selects the maximum number of index images that will be printed on the selected format for the index print. The reverse selection can also be provided where the user selects the number of index images, and the size of the index images is determined accordingly by controller 110, or a default number and size can be provided. The user can select the number of representative images that will be printed on the index print by way of the menu shown on display 122. In a less preferred embodiment, the user can draw boxes on the card or a similar sized media, or indicate by way of stickers or other application of contrasting colors so that scanner 130 can capture imagery such that controller 110 can determine the size and shape of the desired representative imagery. In this fashion, the user need not be constrained by standard size and shape offerings.

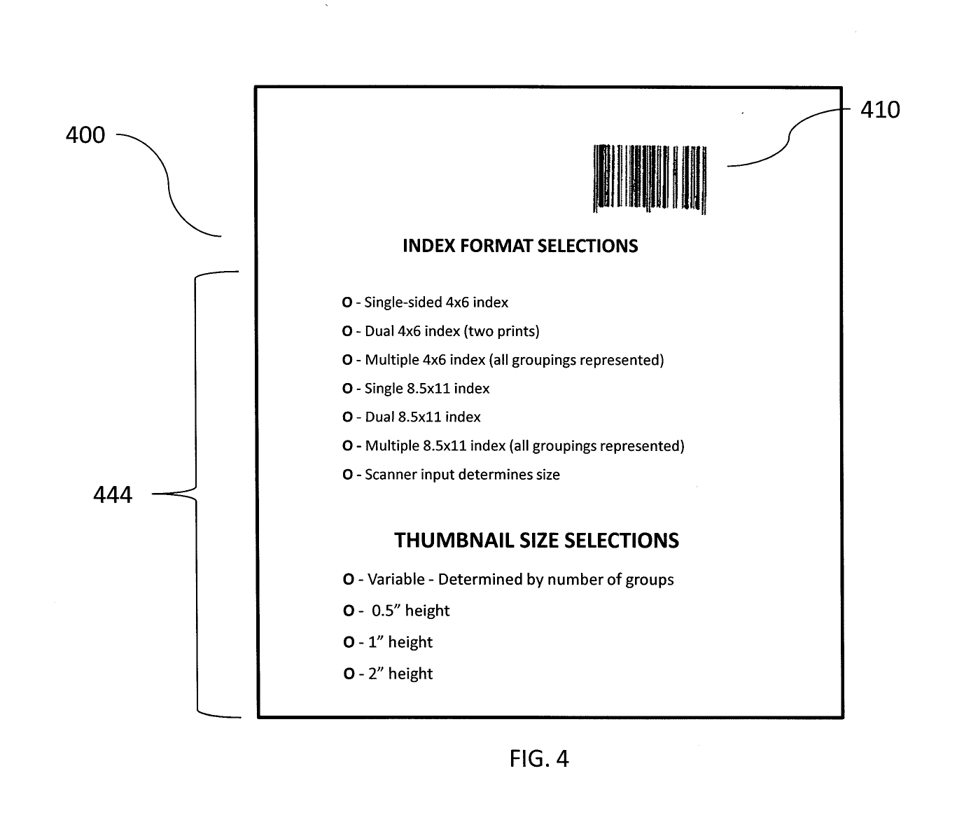

Referring to FIG. 4, the parameters selected above can also be selected by the user via a form 400 for input printed by printer 134. Form 400 has selection boxes 444 that can be marked by the user to communicate selections, once the marked form is scanned. Form 400 can contain bar code 410 to indicate that purpose of form 400 to controller 110. By printing, marking and scanning form 400, the user can readily indicate the parameters to be used for the index output file and index print without constraints by the small size of display 122.

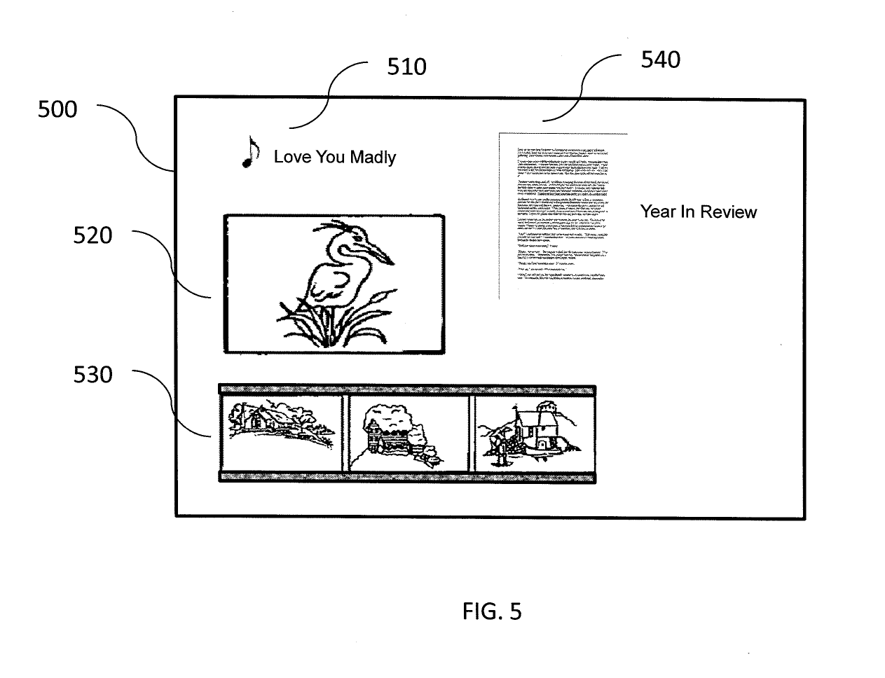

Representative imagery need not be of the same number, size or type for each of the groups. As shown for index print 500 in FIG. 5, representative imagery 510 for a group of audio files can be a small icon with text. Representative imagery 520 for a group of images can include a index image of a size that is useful for identification with no text. Representative imagery 530 for a group of video files can include a grouped series of images. Representative imagery 540 for a group of documents can be a small icon with text.

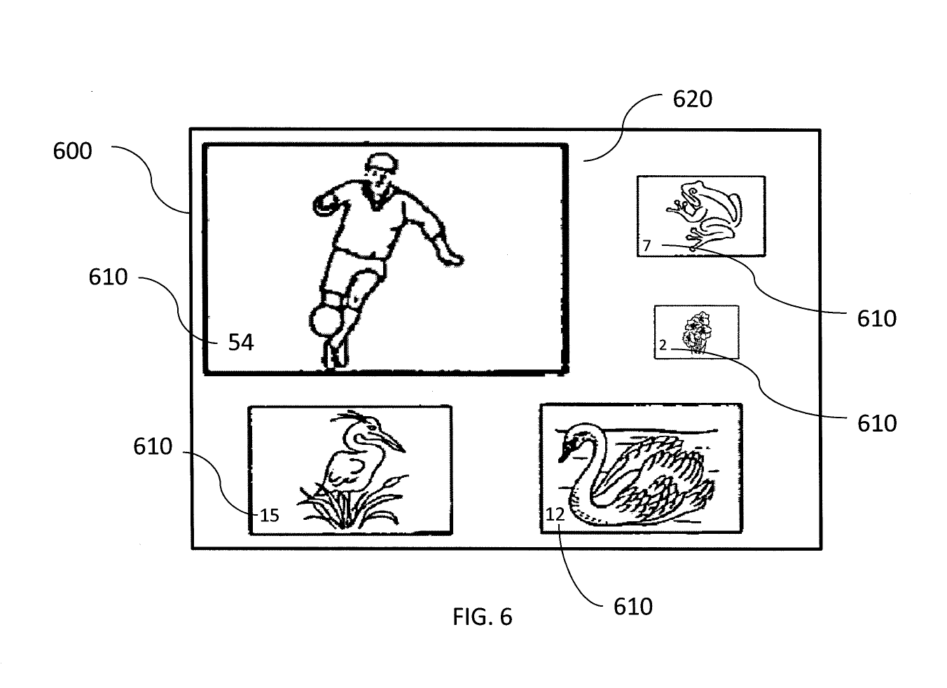

It is useful to provide an assessment of the number of files in a group. As shown in index print 600 of FIG. 6, this can be numeral 610 indicative of the number of files in the group, or a differing treatment such as shadow 620 of representative imagery. Larger groups can be represented by imagery of larger size, higher contrast, or backdrops or shadows that indicate a stack of printed files. Using the example of image size, the group with 54 images can be represented by a large image while a group with 2 images is represented by a much smaller image.

In a preferred embodiment, after an output format has been selected, controller 110 can use the selected output size to create a useful index output file and index print. An index print is considered useful when a balance is struck between index image size and total number of index images. Limits for index image size and total number of index images may be selected by the user, or may be predetermined on the basis of selected output format. Index images printed should be of an adequate size to be readily recognized, but there should be an adequate number of index images to characterize the image files on the memory device. This balance can be achieved by adjusting grouping parameters on the basis of the number of images on the memory device and also the time and date of capture. In the example of an index output file and index print for a camera memory card and the selection of a single-sided 4×6 index print, controller 110 can print representative index images of a size that provides a representative image for each group if there are a limited number of groups. FIG. 6 shows an index generated for a memory device having 5 groups.

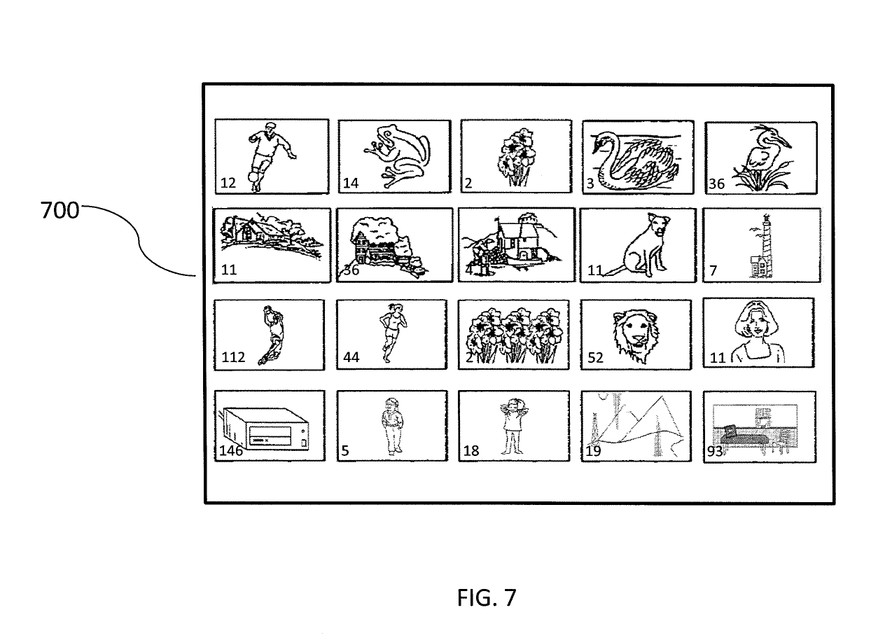

This cannot be the case for large capacity cards with many groups. The parameters for grouping can be altered in light of some minimum size of useful representative imagery, such as images of 0.5 inches in height. In the example of a large capacity card with many groups, and a single sided 4×6 index output format selected, printing a representative image from each of 100 groups will yield representative imagery of a size that is too small to be useful. If the 100 groups were determined using a grouping parameter of 1 day differential, this parameter can be changed to 7 days, and the number of groups is reduced. The 20 groups determined can now provide representative imagery that will comfortably fit on a 4×6 output format 700 as shown in FIG. 7. The processor has adjusted the grouping parameters such that the number of groups represented by index images is less than a predetermined limit, which in this example is 21, corresponding to the selected output format, which in this example is 4×6. The processor can accept a range of results for producing the index output file and index print. In other words, if the grouping parameter selected yields 18 groups, index images representative of those 18 groups are printed.

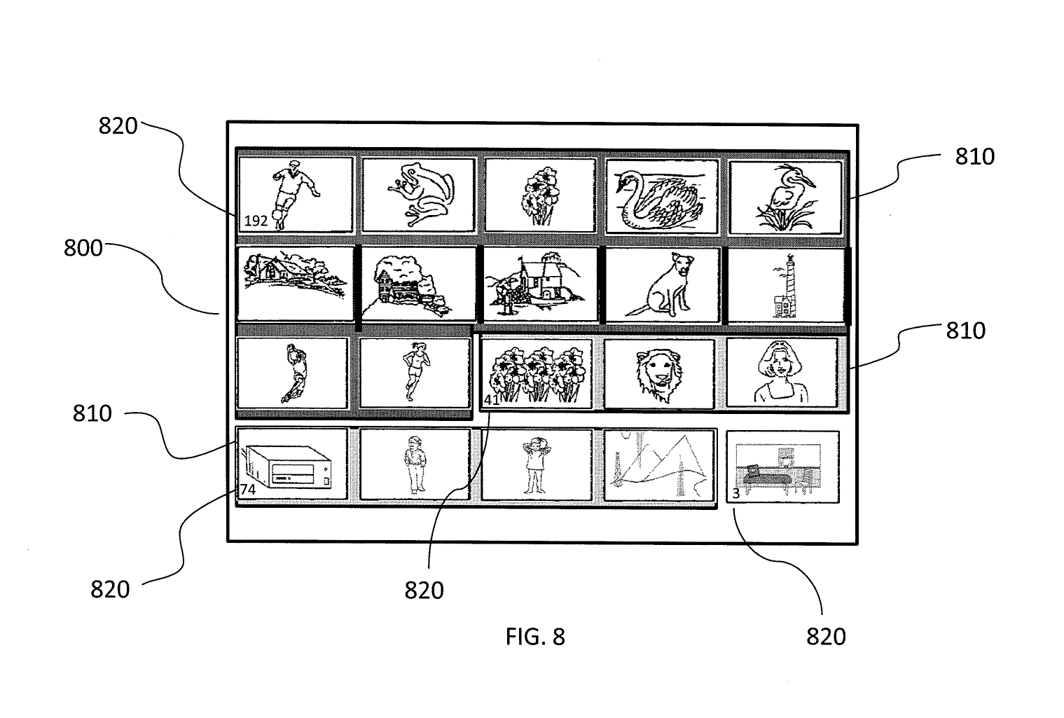

For a memory device with a limited number of groups, multiple representative images can be selected for each group. Using an arbitrary selection of 20 images per index print, for an index print with only 4 groups, 5 images can be selected for each group. If the groups are not of equal size, more images from the larger groups can be selected, and less from the smaller groups. This example assumes each of the representative images are of equal size. This is demonstrated in FIG. 8. Index print 800 has three grouping boxes 810 which denote that all of the index images belong to that group. The first grouping box 810 has 192 images represented by 12 index images; the second grouping box 810 has 41 images represented by 3 index images; and the third grouping box has 74 images represented by 4 index images. There is no fourth grouping box because one group is small enough to be adequately represented by a single index image. One index image in each grouping box, and the index image that is not in a grouping box, have indicating numbers 820 that show the total number of images in the group on the memory device which is represented by the index images in that grouping box 810. Though FIG. 8 shows one embodiment using grouping boxes 810, there are other ways of indicating grouping on the index print 800. Multiple overlapping index images or indicators such as tic marks can alternatively be used to indicate grouping.

If multiple representative images are selected for a particular group, the representative images can be selected with regard to a plurality of selection criteria in order to provide contrasting images within that group. For example, at least one mostly-face or faces image, and at least one image without faces or with minimal sized faces can be selected. In this fashion, a sense of who was present for this group and where this group of images was captured can be provided.

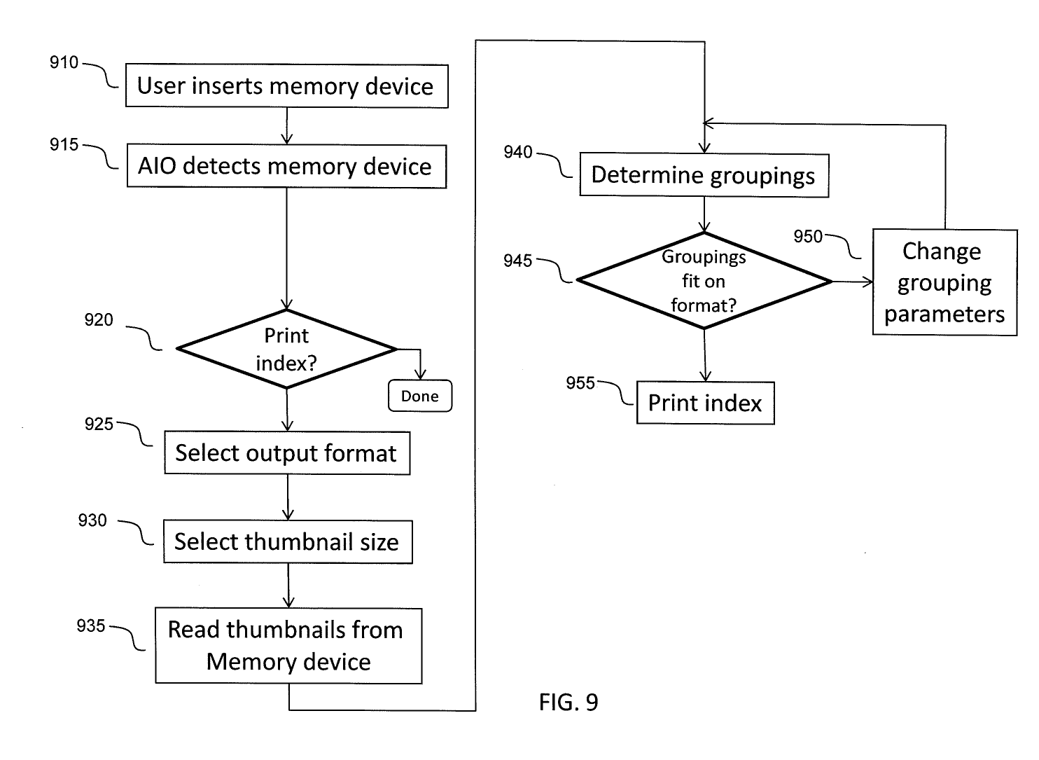

FIG. 9 is a flowchart of steps implementing an embodiment of the invention. In step 910, the user inserts the memory device into connection to external memory 138. AIO printer 100 detects the memory device in step 915. A display 122 provides the user with a message asking if an index print 800 is desired, and the user indicates preference in step 920. If the user selects printing an index print 800, he then selects output format and index image size in steps 925 and 930. In step 935, controller 110 reads index images with associated metadata from the memory device. Groupings based on metadata such as for example time and date of image capture are determined in step 940. A default grouping interval such as one week can be used at this point. As indicated by step 945, if the number of groupings determined in step 940 fit on the selected index format and can be optimized for the selected output format and index image size, then the index output file is created and index print is printed in step 955. If the number of groupings is not optimized for the selected output format and index image size, then the grouping parameter is adjusted in step 950. Groupings are determined once again in step 940. This process is repeated until the number of groupings is optimized for the selected output format and index image size.

Though a preferred embodiment has been described for image files with time of capture as the grouping criterion, the invention is not so limited. In a similar fashion, images or other file types are grouped by naming convention, by file type suffix, or even content within the files. Sub or super groups are determined by cascading these discriminators with time and date of creation or revision. Once groupings have been determined, grouping parameters are adjusted according to number of groups and the selected index format. Then the index is created as previously described. Note that the index images in the case of non-image files will not often be small representations of the file, since these index images have little utility. These index images will more often be icons representative of the file type, or a descriptive bit of content such as text from the file.

The invention as described has been directed primarily toward printing index image files, but the invention can also be used to create index image files for the selected output format that are not printed. In some cases, it can be desirable for the index image file for the index print 800 to be stored externally to AIO printer 100. In this case, controller 110 sends the index image file to an external device via connection to computer 142. The connection may not, in fact, be to a computer, but some other image utilization or storage device. The index image file can be accessed electronically to indicate what images are stored on the memory device.

The preferred embodiment has been described as implemented on and AIO printer. However, the benefits of the invention can also be provided by a printing system such as a kiosk capable of reading memory devices and printing index prints.

The invention has been described with reference to a preferred embodiment. However, it will be appreciated that variations and modifications can be effected by a person of ordinary skill in the art without departing from the scope of the invention.

### PARTS LIST

100 AIO printer
110 controller
114 program memory
116 workspace memory
118 control panel
122 display
130 scanner
134 printer
138 external memory
142 computer
222 options
250 size″ option
333 selections
400 form
410 bar code
444 selection boxes
500 index print
510 representative imagery
520 representative imagery
530 representative imagery
540 representative imagery
600 index print
610 numeral
620 shadow
700 output format
800 index print
810 first grouping box
820 indicating numbers
910 step
915 step
920 step
925 steps
930 steps
935 step
940 step
945 step
950 step
955 step

1. A method for indexing and printing images on a printing system, the method comprising:
a. inputting images with metadata into the printing system;
b. by means of the metadata, selectively grouping the images into a plurality of groups by a controller of the printing system;
c. selecting at least one representative image as an index image from each group;
d. selecting an output format; and
e. using the index images to create a index image file corresponding to the selected output format.

2. The method according to claim 1, wherein step b) further includes adjusting the grouping parameters by the controller such that the number of groups represented by index images is less than a predetermined limit corresponding to the selected output format.

3. The method according to claim 1, wherein the metadata includes a date.

4. The method according to claim 1, wherein the metadata includes a time.

5. The method according to claim 1, wherein the metadata includes a file type.

6. The method according to claim 1, wherein step a) includes inserting a memory device into a connector of the printing system.

7. The method according to claim 1, wherein step c) includes selecting a representative image based on the metadata.

8. The method according to claim 7, wherein the metadata includes a time and date.

9. The method according to claim 1, wherein step c) includes analyzing of image content.

10. The method according to claim 9, wherein analyzing of image content includes detection of faces.

11. The method according to claim 1, wherein step e) includes selecting an output format via a control panel of the printing system.

12. The method according to claim 1, wherein step e) includes selecting an output format via a scanner of the printing system.

13. The method according to claim 12 further including scanning an item having a size to indicate to the controller a desired size for the output format.

14. The method according to claim 1, wherein step e) includes:
selecting a maximum number of index images to be printed; and
determining a size of the index images by the controller.

15. The method according to claim 1, wherein step e) includes
selecting a size of the index of the index images to be printed; and
determining a number of index images by the controller.

16. The method according to claim 1, wherein step e) includes marking a form and scanning the form via a scanner of the printing system.

17. The method according to claim 1, further including providing an indication of a number of images included in an group.

18. The method according to claim 17, wherein providing an indication of the number of images included in a group includes providing a numeral corresponding to the number of images.

19. The method according to claim 17, wherein providing an indication of the number of images included in a group includes sizing the index image corresponding to the number of images.

20. The method according to claim 1, wherein multiple index images are selected for at least one group, the method further comprising providing indicative marks to identify the multiple index images that are part of the one index group.

21. The method according to claim 20, wherein the multiple index images are selected for the one index group according to a plurality of selection criteria.

22. The method according to claim 1, wherein the arranged index images are printed on the selected output format.

23. The method according to claim 1, wherein the number and size of groups represented by index images is predetermined by the selected output format.
